(19) United States
(12) Patent Application Publication
(10) Pub. No.: US 2026/0020525 A1
(43) Pub. Date: Jan. 22, 2026

(54) SYSTEMS AND METHODS FOR ACTIVE TERRAIN COMPENSATION

(71) Applicant: DEERE & COMPANY, Moline, IL (US)

(72) Inventors: Nikhil B. Chavan, Koregaon (IN); Mehul P. Bhavsar, Pune (IN); Sarvesh Aundhkar, Kolhapur (IN); Hrishikesh H. Tupe, Pune (IN); Bryan E. Dugas, Thibodaux, LA (US)

(21) Appl. No.: 18/775,738

(22) Filed: Jul. 17, 2024

(51) Int. Cl. A01D 45/10

(52) U.S. Cl. CPC A01D 45/10

(57) ABSTRACT

A system and method are provided for proactively adjusting a height of an agricultural machine, or components thereof, using at least terrain elevation information provided by, or incorporated into, a terrain map. Moreover, the system can be configured for proactively determining a setpoint for the height(s) of the agricultural machine, or associated components, based a determination that involves at least one or more of a machine sink of the agricultural machine, a tilt offset of the agricultural machine, and elevation differences between a field and an adjacent headland, among other considerations. The system can further evaluate the time for the agricultural machine to reach a location, such as, for example, a location at which terrain elevation changes, an agricultural operation at least temporary stops or resumes, an end of a crop row, or a headland boundary such that such height adjustment(s) occur proactively, including in view of inherent system latencies.

### FIELD OF THE DISCLOSURE

The present disclosure generally relates to harvesting an agricultural material, and, more specifically, to system and methods for attaining predictive field terrain elevations for proactive control of the positioning of harvesting equipment and associated components.

### BACKGROUND

Agricultural harvesting vehicles, including, for example, harvesters and combines, can include an agricultural harvesting head that can also be referred to as header. Traditionally, the header separates crop from the ground, and carries the separated crop rearward through an opening in the header. The crop can then be delivered to other portions of the agricultural harvesting vehicle, wherein the crop can be subjected to further processing, such as, for example, threshing, separation, and cleaning operations, among other operations.

### SUMMARY

The present disclosure may comprise one or more of the following features and combinations thereof.

In one embodiment of the present disclosure, a system is provided for proactively adjusting a height of a component of an agricultural machine. The system can include a first sensor, and an actuator that can be configured to drive an adjustment in the height of the component, and at least one processor. The system can also include a memory coupled with the at least one processor, the memory including instructions that when executed by the at least one processor can cause the at least one processor to identify, using information provided by the first sensor, a location and an elevation of the agricultural machine, and determine, using information provided by a terrain map, a first terrain elevation at the location of the agricultural machine. The memory can also include instructions that when executed by the at least one processor can cause the at least one processor to determine, using information provided by at least the terrain map, a second terrain elevation at a lookahead location at a lookahead distance from the agricultural machine, and determine, using at least the first terrain elevation, the elevation of the agricultural machine, and a machine height of the agricultural machine, a machine sink of the agricultural machine. Additionally, the memory can include instructions that when executed by the at least one processor can cause the at least one processor to determine, prior to an arrival of the agricultural machine at the lookahead location, and using at least the first terrain elevation, the second terrain elevation, and the machine sink, a setpoint for the height of the component, and generate one or more signals to actuate, prior to an arrival of the agricultural machine at the lookahead location, the actuator to satisfy the setpoint at least upon arrival of the agricultural machine at the lookahead location.

According to another embodiment of the present disclosure, a method is provided for proactively adjusting a height of a component of an agricultural machine. The method can include identifying, using information provided by a first sensor, a location and an elevation of the agricultural machine, and determining, using information provided by a terrain map, a first terrain elevation at the location of the agricultural machine. Additionally, the method can include determining, using information provided by at least the terrain map, a second terrain elevation at a lookahead location at a lookahead distance from the agricultural machine, and determining, using at least the first terrain elevation, the elevation of the agricultural machine, and a machine height of the agricultural machine, a machine sink of the agricultural machine. Further, the method can include determining, prior to an arrival of the agricultural machine at the lookahead location, and using at least the first terrain elevation, the second terrain elevation, and the machine sink, a setpoint for the height of the component, and adjusting, via an activation of an actuator, and prior to an arrival of the agricultural machine at the lookahead location, the height of the component to satisfy the setpoint at least upon arrival of the agricultural machine at the lookahead location.

Additionally, according to another embodiment of the present disclosure, a system is provided for proactively adjusting a height of a component of an agricultural machine to compensate for travel across a headland. The system can include a first sensor, an actuator configured to provide a force for an adjustment in the height of the component, at least one processor, and a memory coupled with the at least one processor. The memory can include instructions that when executed by the at least one processor can cause the at least one processor to receive a signal indicative of at least one of a machine mode of the agricultural machine and a change in an operation of the agricultural machine, and identify, using information provided by the first sensor, a first location of the agricultural machine associated with the signal, the first location being adjacent to the headland. Additionally, memory can include instructions that when executed by the at least one processor can cause the at least one processor to determine, using at least information provided by a terrain map, a first elevation for the first location, and determine a setpoint for the height of the component at the first location, the setpoint being based at least on a difference between the first elevation and an elevation of the headland.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a side view of an exemplary agricultural machine in the form of a sugar cane harvester.

FIG. 2A illustrates a top view of the agricultural machine shown in FIG. 1 harvesting an agricultural material in a field.

FIG. 2B illustrates a top view of the agricultural machine shown in FIG. 2A in and a portion of the track paths that are followed by engagement bodies of the agricultural machine as the agricultural machine is harvesting agricultural material in a field and traveling in opposing headlands.

FIG. 2C illustrates a side view of the agricultural machine shown in FIG. 1 and an associated reference point(s) that can be utilized to at least determine elevation and machine sink information.

FIG. 3 illustrates a simplified block diagram of an exemplary system for proactively predetermining setpoints for one or more components of agricultural machine.

FIG. 4 illustrates a simplified flow diagram of an exemplary method for proactively determining and adjusting settings for one or more components of an agricultural machine, and for compensating in changes in height control relating to at least machine sink and machine tilt.

FIG. 5 illustrates a simplified block diagram of an exemplary portion of the system shown in FIG. 3 for proactively determining and adjusting setpoints for one or more components of an agricultural machine.

FIG. 6 illustrates a simplified flow diagram of an exemplary method for proactively determining and adjusting settings for one or more components of an agricultural machine based at least on terrain elevation at the start and end points for harvesting agricultural material.

FIG. 7 illustrates a simplified block diagram of an exemplary portion of the system shown in FIG. 3 for proactively determining and adjusting setpoints for one or more components of an agricultural machine.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

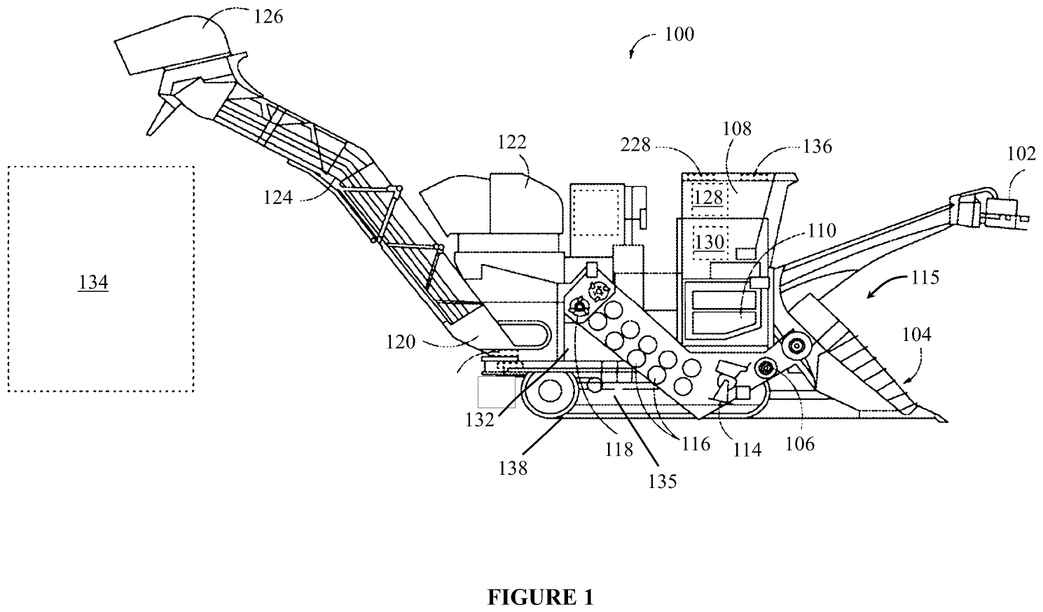

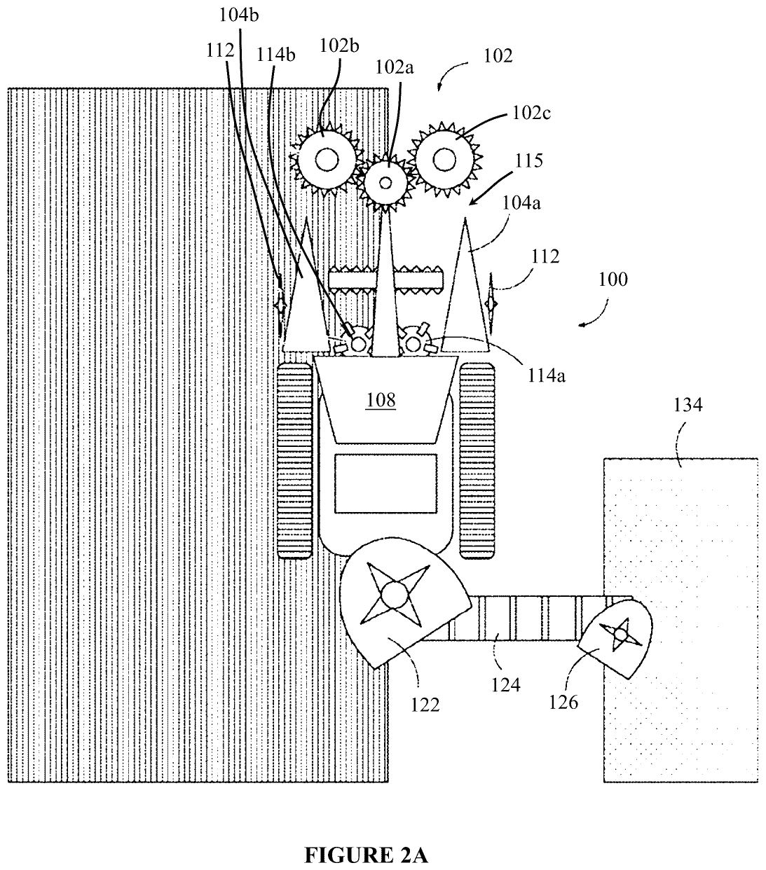

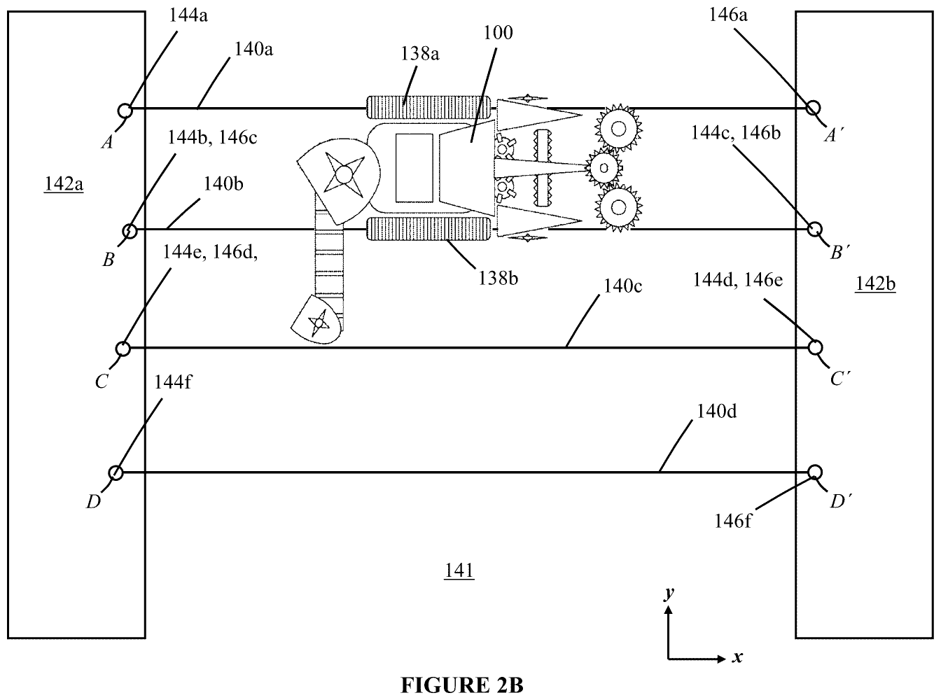

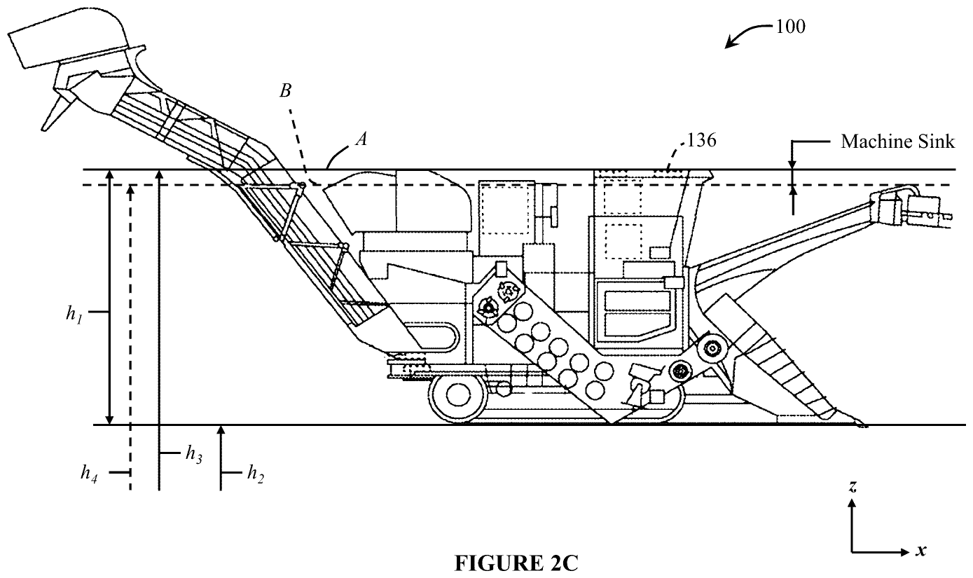

FIGS. 1 and 2A illustrate an exemplary agricultural machine 100 for harvesting at least one types of agricultural material. Moreover, FIG. 1 illustrates an exemplary agricultural machine 100 in the form of a sugar cane harvester configured for harvesting sugar cane. While FIG. 1 illustrates one type of harvester for the agricultural machine 100, other harvesters can be utilized in place of the illustrated sugar cane harvester, including, for example, harvesters or combines utilized to harvest other types of agricultural material, including crops. Additionally, while the agricultural machine 100 is discussed below in connection with a particular type of conveyance assembly for transporting the harvested agricultural material about the agricultural machine 100, other types of conveyance assemblies can be utilized, including, for example, conveyance assemblies associated with other types of agricultural materials, of for transporting loose materials other than harvested agricultural material, including, but not limited to, mining materials, such as, for example, rocks and earth, among other loose materials.

The illustrated agricultural machine 100 can include a cab 108 to seat an operator, as well as a chassis 132 for supporting various cutting, routing and processing devices. In certain embodiments, the chassis 132 can be supported by a transport frame, such as track frame 135 supporting ground engagement bodies 138, such as, for example, track assemblies or wheels that contact, and are utilized in the propulsion of the agricultural machine 100 along, the ground surface.

The illustrated exemplary agricultural machine 100 can include a topper 102 that extends forward of the chassis 132 and can be configured to cut leaves off of the top or upper areas of the agricultural material being harvested. According to certain embodiments, the topper 102 can include a plurality of disks 102a, 102b, 102c that can be configured to cut the tops of the agricultural material being harvested, as well as to assist in discharging the cut portion of the agricultural material to an adjacent portion of the field in which agricultural material may have already been harvested by the agricultural machine 100. The direction of rotation of one or more of the disks 102a, 102b, 102c can be utilized to control the direction the disk(s) discharge the cut portion of the agricultural material (e.g., to the right or left side of the agricultural machine 100).

The illustrated agricultural machine 100 can also include crop dividers 104 that can be coupled to the chassis 132 that are configured to divide the agricultural material being harvested using the agricultural machine 100 into separate rows so as to at least attempt to prevent uprooting of the agricultural material. The height of the crop dividers 104 relative to at least the adjacent ground surface or chassis 132 of the agricultural machine 100 can be selectively adjusted by an operator of the agricultural machine 100, such as, for example, via operation of one or more actuators. Additionally, according to certain embodiments, such height adjustment of at the crop dividers 104 can be independent of an adjustment to the height, if any, of the overall agricultural machine 100, and/or independent of one or more other crop dividers 104.

A knockdown roller 106 of the agricultural machine 100 can be configured to push the agricultural material being harvested from the field in a generally forward direction so that base cutters 114 of the agricultural machine 100 can at least attempt to cut the agricultural material in the field at, or around, ground level. According to certain embodiments, the base cutters 114, which can be coupled to the chassis 132, can be configured to cut the agricultural material in a substantially horizontal plane. As seen in at least FIG. 2A, the base cutters 114 can comprise a plurality of base cutters 114a, 114b, such as, for example, one or more right side base cutters 114a, and one or more left side base cutters 114b. According to certain embodiments, the height of the base cutters 114a, 114b (collectively referred to herein as base cutters 114) can be dependent on the height of the agricultural machine 100. Thus, for example, adjusting the height of each, or both, of the base cutters 114a, 114b can involve operating one or more actuators that can facilitate a change in height of at least a portion of the agricultural machine 100, such as, for example, the chassis 132, such that at least the vertical position of the base cutters 114a, 114b relative to the ground surface is adjusted (e.g., raised or lowered). Alternatively, or additionally, the vertical position of the base cutters 114a, 114b can be adjusted independent of changes in the height of the agricultural machine 100. For example, the height of the agricultural machine 100, including, for example, the height of the chassis 132 relative to the adjacent ground surface, can, for some agricultural machines 100, remain generally static as one or more actuators are utilized to adjust the vertical height of the base cutters 114a, 114b. Further, according to certain embodiments, the height of the agricultural machine 100, such as, for example, the chassis 132, can be adjustable to accommodate generally larger, or coarse, adjustments of the height of the base cutters 114a, 114b, and one or more actuators can be utilized for adjusting the height of one or more base cutters 114 relative to the agricultural machine 100 and ground surface so as to accommodate finer adjustments in the height of the base cutters 114. Additionally, the height of at least some base cutters 114a can be selectively adjusted independent of changes, if any, to the height of at least another base cutter 114b, and vice versa. Further, while the illustrated exemplary agricultural machine 100 depicts the agricultural machine 100 as having a single pair of base cutters 114a, 114b, the agricultural machine 100 can have more than one pair of base cutters 114a, 114b, and can instead have a plurality of pairs of base cutters 114a, 114b. For example, according to certain embodiments, the agricultural machine 100 can be a two row harvester, among other harvesters.

The agricultural machine 100 can also include side knives 112 that can be configured to cut agricultural material in a vertical plane substantially parallel with a travel path of the agricultural machine 100.

While certain components are individually discussed herein, for at least certain types of agricultural machines 100, such components can be part of a header 115 of the agricultural machine 100. For example, according to certain types of agricultural machines 100, the agricultural machine 100 can have a header 115 that can include the topper 102, base cutters 114, crop dividers 104, knockdown roller 106. and/or side knives 112, among other components. Additionally, as discussed below, the settings, including height, for at least some components of the header 115 can be different than, or adjusted independent of, other components of the header 115. Thus, for example, the height of the base cutters 114 may be adjusted independently of the height of either or both the crop dividers 104 and the side knives 112, and vice versa, among the heights of other components of the header 115.

FIG. 2A illustrates a top view of the illustrated agricultural machine 100 having first and second crop dividers 104a, 104b (generally referred to herein as crop dividers 104), side knives 112, and base cutter 114b that are positioned on the left side of the agricultural machine 100 engaged in harvesting agricultural material. In the illustrated example in which unharvested agricultural material is positioned to the left, and not to the right, of the depicted exemplary agricultural machine 100, at least the crop divider 104, side knife 112, and base cutter 114 on the left side, and optionally, on the right side, of the agricultural machine 100 may be selectively operated. However, the agricultural machine 100 can include similar crop dividers 104, side knife 112, and base cutter 114a on the right side of the agricultural machine 100 that can also be selectively operated when unharvested agricultural material is positioned at least to the right of the agricultural machine 100. Such operation of the crop dividers 104, side knife 112, and base cutter 114a on at least the right side of the agricultural machine 100 can be independent of, or, alternatively, in connection with, the operation, if any, of the crop dividers 104, side knife 112, and base cutter 114b that are positioned on the left side of the agricultural machine 100. However, in other instances, each crop divider 104, side knife 112, and base cutter 114 can operate simultaneously. Further, while the illustrated agricultural machine 100 is depicted as a single row agricultural machine 100, the agricultural machine 100 can have a variety of different configurations, including, for example, be a multi row harvester.

While an above discussion addressed adjustments of the height of the base cutters 114a, 114b, either together or individually, the heights of other components of a header 115 of the can be adjusted in generally similar manners, either with, or without, adjustments in the height of other components of the header 115. For example, as previously discussed, the header 115 can include a plurality of crop dividers 104a, 104b. According to certain headers 115, similar to the base cutters 114a, 114b, the height of each crop divider 104a, 104b can be selectively adjustment either individually or with one or more, if not all, of the other crop dividers 104a, 104b. Thus, for example, with respect to the illustrated agricultural machine 100, a height of a first crop divider 104a can be selectively adjusted with, or independent of, an adjustment in the height of at least one other crop divider 104b, and vice versa.

After the crop material has been cut by the base cutter(s) 114, feed rollers 116 of the agricultural machine 100 can move the harvested crop toward a chopper 118 that is configured to chop the harvested agricultural material into shorter lengths, and the shorter length agricultural material can then be move to a basket 120. The agricultural machine 100 can also include a primary extractor 122 having a hood and a fan that can move leaves out of a hood of the agricultural machine 100 such that the leaves are not directed into the basket 120. The primary extractor 122 can be selectively pivoted to direct the leaves to the headland or a previously harvested portion of the field.

The illustrated agricultural machine 100 can also include a conveyor 124, such as, for example, a slat conveyor or auger, among other types of conveyors, positioned to move harvested agricultural material from the basket 120 and into a wagon 134. The conveyor 124 can therefore extend in a direction that directs the harvested agricultural material into the wagon 134. Further, in the illustrated example, as the wagon 134 is depicted as traveling over areas of the field in which the agricultural material has already been harvested, the illustrated conveyor 124, at least currently, extends in a direction away from the adjacent portion of the field having agricultural material that has not yet been harvested. The agricultural machine 100 can also include a secondary extractor 126 having a hood and a fan that are configured for the secondary extractor 126 to move any remaining leaves out of the hood in a manner in which the leaves are not directed into the wagon 134.

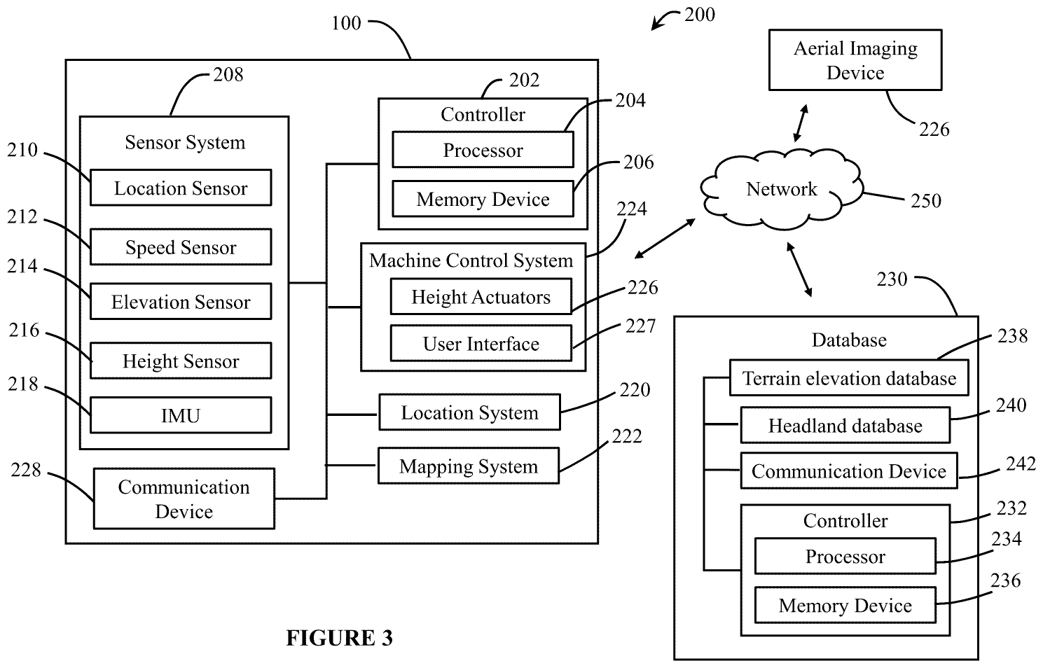

FIG. 3 illustrates a simplified block diagram of an exemplary system 200 for proactively predetermining setpoints for one or more components of agricultural machine 100, including, for example, setpoints relating to the header 115, such as a height of the base cutters 114, crop dividers 104, or the agricultural machine 100, as well as any combination thereof, among other setpoints. As discussed herein, height can relate to at least a height above a ground surface and/or the chassis 132, such as, for example, generally in the “z” direction that is generally orthogonal to the ground surface shown in FIG. 2C.

The system 200 can include one or more controllers 202 having at least one processor 204 and at least one memory device 206. The controller 202, processor(s) 204, and/or memory device(s) 206 may, or may not, be dedicated to the operation of the system 200, or components of the system 200, including the agricultural machine 100. Thus, for example, according to certain embodiments, the processor 204 can comprise one or more processors, including compute circuits, that can be utilized to control operation of the system 200, and, optionally, can also be utilized in connection with controlling the operation of one or more components agricultural machine 100, including, but not limited to, the height(s) of the agricultural machine 100, base cutters 114, or crop dividers 104, as well as any combinations thereof, among other components. Therefore, according to certain embodiments, one controller 202, including one or more processors 204 of that controller 202, can be utilized to control operation of at least the system 200, or the corresponding components of the system 200. Alternatively, a plurality of controllers 202, or combinations of processors 204, including compute circuits, can be utilized to control operation of the system 200, as well as control operations of different components of the agricultural machine 100. Thus, for example, while certain embodiments herein may mention functions being performed by a controller 202, including the associated processor 204, such functions can be performed by a single controller or processor, or, alternatively, one or more functions can be performed by one or more controllers or processors, and one or more other functions can be performed by one or more other controllers or processors or combinations of controllers or processors.

The memory device 206 can have instructions stored therein that are executable by the processor 204 to cause the processor 204 to receive input, such as, for example, from one or more sensors 210, 212, 214, 216, 218 or the location system 220, as well as any combination thereof, among other inputs. The processor 204 can be embodied as, or otherwise include any type of processor, controller, or other compute circuit capable of performing various tasks such as compute functions and/or controlling the functions of at least the system 200. For example, the processor 204 can be embodied as a single or multi-core processor(s), a microcontroller, or other processor or processing/controlling circuit. In some embodiments, the processor 204 can be embodied as, include, or otherwise be coupled to an FPGA, an application specific integrated circuit (ASIC), reconfigurable hardware or hardware circuitry, or other specialized hardware to facilitate performance of the functions described herein. Additionally, in some embodiments, the processor 204 can be embodied as, or otherwise include a high-power processor, an accelerator co-processor, or a storage controller.

The memory device 206 can be embodied as any type of volatile (e.g., dynamic random-access memory (DRAM), etc.) or non-volatile memory capable of storing data therein. Volatile memory may be embodied as a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

In some embodiments, the memory device 206 can be embodied as a block addressable memory, such as those based on NAND or NOR technologies. The memory device 206 can also include future generation nonvolatile devices, such as a three-dimensional crosspoint memory device (e.g., Intel 3D XPoint™ memory), or other byte addressable write-in-place nonvolatile memory devices. In some embodiments, the memory device 206 can be embodied as, or may otherwise include, chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device 206 can refer to the die itself and/or to a packaged memory product. In some embodiments, 3D crosspoint memory (e.g., Intel 3D XPoint™ memory) can comprise a transistor-less stackable cross point architecture in which memory cells sit at the intersection of word lines and bit lines and are individually addressable and in which bit storage is based on a change in bulk resistance.

As seen in at least FIG. 3, the agricultural machine 100 can include a plurality of sensors, which, for at least purposes of discussion, can be referred to herein as being part of a sensor system 208. The below mentioned exemplary components of the sensor system 208 can be communicatively connected to the controller 202 to communicate sensed information, including sensed data, via a wired and/or wireless connection.

The sensor system 208 can include a location sensor or receiver 136 (generally referred to herein as location sensor) that can be positioned on the agricultural machine 100, such as, for example, on a roof of the cab 108. Although illustrated in FIG. 3 as being part of a sensor system 208, the location sensor 210 can be part of a location system 220, such as, for example, a global positioning system (GPS). Further, according to certain embodiments, the location sensor 136 can be utilized to connect the location system 220 to, or receive information from, one or more GPS satellites. Information provided by the location system 220 or the location sensor 210 can indicate a location of the agricultural machine 100, including, but not limited any or all of a longitudinal location, latitudinal location, and elevation of the agricultural machine 100. Further, information provided by the location system 220 or the location sensor 210 can also be used to determine a direction of travel, heading, or compass bearing of the agricultural machine 100, among other information.

The sensor system 208 can further include a speed sensor 212 that can be utilized to identify a speed of travel of the agricultural machine 100, including a ground speed of the agricultural machine 100. However, such speed information can also be attained in a variety of different manners, including using information from location system 220 or the location sensor 210, such as, for example, GPS information over or between a period of time.

Optionally, the sensor system 208 can further include an onboard elevation sensor 214 that is configured to provide information regarding an elevation of the agricultural machine 100. However, the elevation of the agricultural machine 100 can be determined in a variety of manners, including, for example, via use of terrain elevation information provided by one or more terrain maps, as discussed below, as well as using information provided by the location sensor 210 or location system 220.

The sensor system 208 can also include one or more, including a plurality, of position or height sensors 216 (referred to herein as height sensors 216). For example, according to certain embodiments, one or more first height sensors 216 can be utilized to identify a height of the agricultural machine 100, such as, for example, a height of a chassis 132 of the agricultural machine 100 relative to the adjacent ground surface. Additionally, or alternatively, one or more second height sensors 216 can be utilized to determine a height of one or more base cutters 114, including, but not limited to, the height of one or more right base cutters 114a and one or more left base cutters 114b. Further, according to certain embodiments, one or more third height sensors 216 can be utilized to determine a height of one or more, if not all, crop dividers 104. The second and third height sensors 216 utilized with the base cutters 114 and crop dividers 104, respectively, can be configured to provide information indicative of the base cutters 114 and crop dividers 104 relative to the chassis or the ground surface, as well as combinations thereof.

The sensor system 208 can also include an internal measurement unit (IMU) 218 that can, according to certain embodiment, include an accelerometer that can measure a static orientation of the agricultural machine 100, and/or a gyroscope that can measure the dynamic orientation of the agricultural machine 100 for each of the three axes, such as, for example: pitch (generally about the “y” axis shown in FIG. 2B); roll (generally about the “x” axis shown in FIGS. 2B and 2C); and, yaw (generally about the “z” axis shown in FIG. 2C). Moreover, the roll can be calculated as rotation along a longitudinal axis extending in the direction of travel, the pitch can be rotation about a horizontal axis perpendicular to the direction of travel, and the yaw can be rotation about a substantially vertical axis.

The agricultural machine 100 can further include a machine control system 224 that can include a plurality of actuators, including, for example, height actuators 226. The height actuators 226 can be configured to selectively adjust the height of either or both the agricultural machine 100 and one or more components of the agricultural machine 100, including, for example, the header 115 or components of the header 115, among other components at or around the front end of the agricultural machine 100. For example, according to certain embodiments, the height actuators 226 can include one or more first height actuators 226 that can be utilized to selectively adjust a height of the agricultural machine 100, also referred to herein as machine height, including, for example, a height of the chassis 132 relative to the adjacent ground surface. As previously discussed, such adjustment in the height of the chassis 132 can, according to certain embodiments, also result in a change of height of the header 115 or components of the header 115, including, for example, either or both the base cutters 114 and crop dividers 104, among other components at the front end of the agricultural machine 100. Additionally, according to certain embodiments, one or more second height actuators 226 can be utilized to selectively adjust the height of one or more base cutters 114, as previously discussed, including independent of the machine height of the agricultural machine 100 and/or independent of the height of one or more other base cutters 114a, 114b, among other components at the front end of the agricultural machine 100. Further, according to certain embodiments, one or more third height actuators 226 can be utilized to selectively adjust the height of one or more crop dividers 104, as previously discussed, including independent of the height adjustment of the agricultural machine 100 and other components at the front end of the agricultural machine 100. Activation of the height actuators 226 can, according to certain embodiments, be controlled via one or more signals generated by the controller 202.

The machine control system 224 can also include a user interface 227 that user can use to interact with the controller 202. The user interface 227 can include one or more input/output (I/O) devices, such as, for example, a steering wheel, joystick, button, keyboard, mouse, touch screen, display, microphone, and speaker, among other I/O devices. The user interface 227 can be utilize by the operator to input other otherwise provide a variety of information to the controller 202 that may also be stored for historical purposes, including, but not limited to, information regarding where harvesting along one or more rows of crop is to begin and/or to end, among other information. Additionally, the user interface 227 can be utilized to communicate information to the operator, including, for example, communicate information regarding certain setpoints, and changes in such setpoints, including, for example, with respect to machine height, height of the base cutters 114, and/or the height of crop dividers 104, among other information. The user interface 227 can further be used by an operator to input a selected mode of operation of the agricultural machine 100, including, for example, a cutting or harvesting mode of operation. The user interface 227 can also include gauges that can display pitch, yaw and roll of the agricultural machine 100, as indicated by information obtained by the IMU 228, among other information.

The system 200 can also include a mapping system 222 that can include logic for generating a variety of different types of maps, including, but not limited to terrain elevation maps, terrain maps, maps indicating starting/ending points of crop rows, and/or soil compaction maps, including, for example, compaction relating to track paths 140a-d (FIG. 2B) along which one or more ground engagement bodies of one or more agricultural machines, equipment, or implements will, or have, traveled, among a field.

The agricultural machine 100 can further include a communication device 228 that can communicate information from, as well as receive information to, the system 200, including, but not limited to, to/from other agricultural machines and devices, such as, for example, aerial imaging devices 226 and databases 230, among other off-board devices. The communication device 228 can be embodied as hardware, firmware, software, virtualized hardware, emulated architecture, and/or a combination thereof. According to certain embodiments, the communication device 228 can comprise a transceiver that is configured to wirelessly communicate information, as well as receive information, that may pertain to, or assist, the controller 202 in determining or identifying terrain features for the ground upon which the agricultural machine 100 is, or will be, traveling, including terrain features relating to topography, such as, for example, elevation of the terrain.

The communication device 228 can, according to certain embodiments, exchange communications with a communication device 242 of one or more off-board devices, such as, for example, a database 230, via a network 250, including, for example, via internet, cellular, or Wi-Fi networks, as well as combinations thereof. Such communications can include communication of information that may, or may not, also be stored on-board the agricultural machine 100, including stored at the memory device 206. The database 230, which, according to certain embodiments, can be a cloud based database, can store field data, including, but not limited to, a terrain map(s) that can include terrain elevation information, an information regarding the agricultural material on the terrain, and/or headland information, including start/end points for rows of crop and/or headlands, as well as combinations thereof, among other information, relating to the field, or an associated area, on which the agricultural machine 100 is, or will be, performing an agricultural operation.

The terrain map can include, among other information, pre-recorded terrain characteristics, including the locations, such as, for example, GPS coordinates of the terrain characteristics. Such terrain characteristics can include terrain topology information, including terrain elevations or changes in terrain elevation and the locations thereof, such as, for, example, the locations of protrusions, recesses, and slopes, among other information or variances in the field that can impact at least the height(s) of one or more components of the agricultural machine 100, including, for example, the base cutters 114 and crop dividers 104, among other components. The terrain characteristics can also include locations of crop materials and detected obstacles, including obstacles that may be above, at least partially obscured beneath, or concealed below the ground, as well as combinations thereof, among other terrain characteristics.

According to certain embodiments, the field data, including the terrain map(s) that can include terrain elevation information, among other information, can be at least initially generated by the mapping system 222 of the agricultural machine 100 during a prior performance of an agricultural operation. For example, terrain height data can be gathered while a planting and/or spraying operation is being performed in a field 141. Additionally, or alternatively, such terrain height data can be gathered, supplemented, confirmed, and/or adjusted during one or more past harvesting cycles. Additionally, or alternatively, the field data can include elevation data, such as GPS elevation data, that can be attained during operation of the agricultural machine 100.

Such terrain information can also be based on information inputted by an operator of the agricultural machine 100, including, for example, an indication of the start or end location for a row(s) of crop material(s) and/or the start/end of a harvesting operation, such as, for example, a start location and/or an end location of a cutting operation by the base cutter 114. Such generated field data can be communicated to, and stored by, a database 230, including a memory device 236 of the database 230, as well as stored by a memory device 206 of the agricultural machine 100 that generated that field data. Additionally, the field data can be updated, or replaced, by field data subsequently generated during the performance of other agricultural operations.

The database 230 can further include a headland database 240 that can include information regarding the location of one or more headlands 142a, 142b (FIG. 2B), as well as the boundaries of the headlands 142a, 142b, including relative to one or more fields 141. Such a headland database 240 can further include information regarding historical setpoints for one or more components of the of the agricultural machine 100, including, for example, height settings of the base cutter 114, crop dividers 104, or agricultural machine 100, among other components of the header 115 or at the front end of the agricultural machine 100, at one or more locations at, or relative to, the headlands 142a, 142b, among other historical setpoints.

According to certain embodiments, the database 230 can also include a controller 232 having at least one processor 234 and at least one memory device 236. The controller 232, processor 234, and memory device 236 can have configurations or embodiments similar to the various configurations or embodiments discussed above to the controller 202, processor 204, and memory device 206 discussed above with respect to the agricultural machine 100.

Field data, including terrain maps having elevation information, among other information, can be provided to the database 230 from one or more other external sources in addition to, or in lieu of, the agricultural machine 100. For example, according to certain embodiments, the system 300 can include, or otherwise utilize information from, one or more aerial imaging devices 226, including, but not limited to, unmanned aerial vehicles, drones, or satellites having imaging devices that can provide field data, including terrain elevation information. For example, according to certain embodiments, the aerial imaging device 226 can have and imaging device that can utilize lidar, among other techniques, to obtain terrain elevation data for various locations about a field, among other areas. Additionally, or alternatively, terrain maps can be obtained using at least information provided by the United States Geological Survey (USGS).

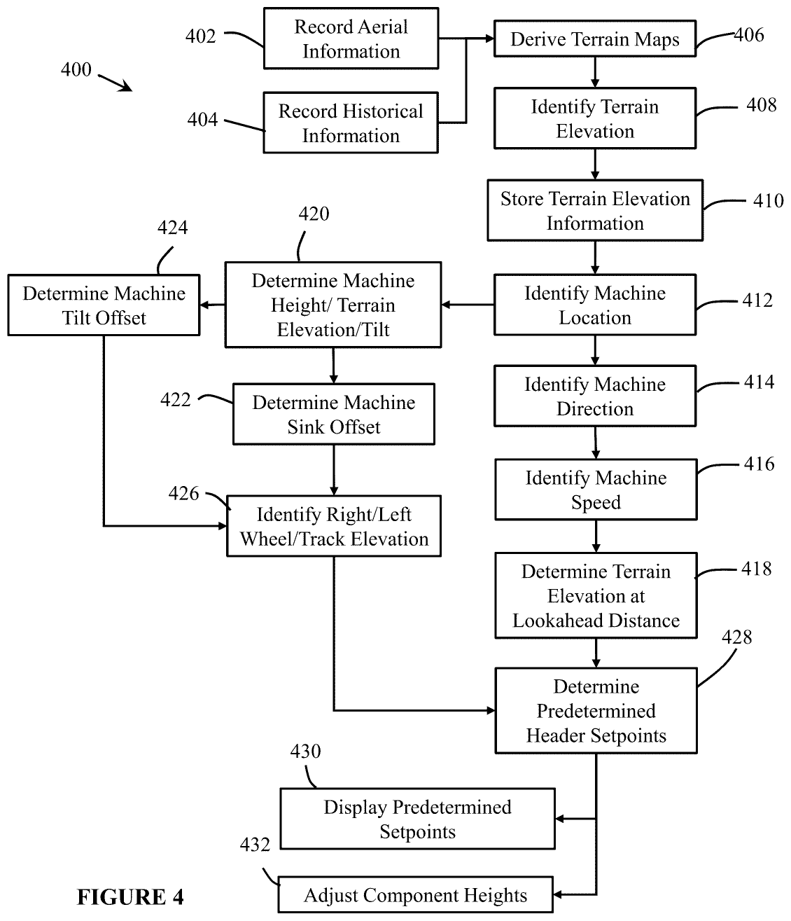

FIG. 4 illustrates a simplified flow diagram of an exemplary method 400 for proactively determining and adjusting settings for one or more components of an agricultural machine 100, and for compensating in changes in height control relating to at least machine sink and machine tilt. The method 400 is described below in the context of being carried out by the illustrated exemplary system 200. However, it should be appreciated that method 400 can likewise be carried out by any of the other described implementations, as well as variations thereof. Further, the method 400 corresponds to, or is otherwise associated with, performance of the blocks described below in the illustrative sequence of FIG. 4. It should be appreciated, however, that the method 400 can be performed in one or more sequences different from the illustrative sequence. Additionally, one or more of the blocks mentioned below may not be performed, and the method 400 can include steps or processes other than those discussed below.

As seen in FIG. 4, at block 402, aerial information can be recorded, such as, for example, field data obtained via use of one or more aerial imaging devices 226, or otherwise provided from other sources, such as, for example, the USGS. For example, as previously discussed, such recorded aerial information can correspond to terrain elevation information provided by a drone or satellite, including, for example, via use of lidar. Additionally, or alternatively, at block 404, historical field data can be gathered, including, for example, terrain elevation information at a variety of locations about a field 141 and/or associated headlands 142a, 142b, that are obtained while one or more agricultural machines perform an agricultural operation, including, but not limited to, planting, spraying, or harvesting, among other agricultural operations, or in connection with one or more harvesting cycles, as discussed above. According to certain embodiments, such historical information can further include information provided by a mapping system 222 of the agricultural machine 100. Additionally, as previously discussed, such aerial information recorded at step 402, as well as historical information gathered at block 404 can, according to certain embodiments, be stored by the database 230, including, for example, one or more of the terrain elevation database 238 and the headland database 240, and/or stored by the memory device 236.

At block 406, one or more controllers 202, 232, including one or more associated processors 204, 234, of the agricultural machine 100 and/or the database 230 can utilize at least the information provided by either or both the recorded aerial information from block 402 and the recorded historical information from block 404 to drive the terrain map. Additionally, as indicated by block 408, to the extent not already provided by the terrain map, topographical information, including, for example, terrain elevation information at one or more locations, can be identified and included with the terrain map. The terrain map and associated terrain elevation information can be stored at block 410, including recorded, such as, for example, at the database 230, including, for example, either or both the terrain elevation database 238 and the headland database 240, and/or stored by a memory device 206, 236 of either or both the agricultural machine 100 and the database 203.

During a performance of an agricultural operation by the agricultural machine 100, such as, for example, a harvesting operation, the location of the agricultural machine 100 can be identified at block 412, such as, for example, via use of the location system, 220 and/or location sensor 210. Thus, according to certain embodiments, the identified location at block 412 can correspond to a GPS location of the agricultural machine 100. Additionally, the location information obtained using the location system 220 and/or the location sensor 210 can, at block 414, be utilized to identify a heading, direction of travel, or compass bearing of the agricultural machine 100, including, but not limited to, whether the agricultural machine 100 is traveling in a forward direction or a reverse direction.

At block 416, the location system 220, the location sensor 210, and/or the speed sensor 212 can be utilized to identify a speed of travel, including, for example, a speed of ground travel, of the agricultural machine 100. Information regarding at least the current location of the agricultural machine 100 (block 412), the heading or direction of travel of the agricultural machine (block 414), and the rate or speed of travel of the agricultural machine 100 (block 416), can be utilized at block 418 by at least one controller 202, 230, and associated processor 204, 234, to determine a lookahead distance the agricultural machine 100 is estimated to travel within a certain time, as well as be used to identify a lookahead location at which the agricultural machine 100 is estimated to reach, or be located at, within that time. Additionally, the terrain map, and, moreover, the terrain elevation information provided by the terrain map can indicate a terrain elevation associated with the lookahead location at the determined lookahead distance. Such forward looking or identification of the future terrain elevation, and the time at which the agricultural machine 100 is estimated to reach that elevation, can be compared to the elevation at the current location of the agricultural machine 100 to identify upcoming changes in terrain elevation. Such determinations regarding at least the upcoming terrain elevation at the lookahead distance or location determined at block 418 can be supplied to block 428 in connection with determined predetermined header setpoints, and, moreover, predetermined presets for one or more components of the header 115 for the terrain elevation associated with one or more locations at the lookahead distance, as discussed below. Additionally, information regarding the location associated with the lookahead distance, and time to reach that location, as well as information regarding inherent system latencies and changes in terrain elevation, if any, can also be utilized in connection with determining the timing for proactive activation of one or more of the height actuators 226, as also discussed below. For example, according to certain embodiments, the lookahead distance can be based on inherent system latencies, including the distance expected to be traveled before the agricultural machine 100 and/or system 200 can identify and implement changes in one or more settings, such as, for example, identifying and completing an adjustment of one or more of the machine height, height of the base cutters 114, and/or height of the crop dividers 104. Further, according to certain embodiments, either or both the lookahead distance and the lookahead location can be based on the time associated with such inherent latencies of the agricultural machine 100 to implement or complete changes adjusting a height of the agricultural machine 100 or associated components.

At block 420, at the location identified at block 412, the controller 202, 230, including, for example, the associated processor 204, 234, can determine at least information regarding a height, elevation, and/or machine sink, among other information, for the agricultural machine 100. For example, as discussed above, with respect to at least certain agricultural machines 100, the height of the agricultural machine 100, including, for example, a height associated with a chassis 132 of the agricultural machine 100 can be adjustable. The height of the agricultural machine 100, as generally indicated by “h₁” in FIG. 2C, can be based on a variety of different locations or reference points about the agricultural machine 100, including, for example, with respect to a location or reference point relating to the location sensor 210 or the roof of the cab 108, among other locations. Additionally, the terrain elevation of the corresponding ground surface, as generally indicated by “h₂” in FIG. 2C, can be provided by terrain elevation information that may be included in the terrain map, as discussed above with respect to at least blocks 408 and 410. Additionally, the extent the agricultural machine 100 is tilted, including, for example, with respect to one or more of pitch, roll, and yaw of the agricultural machine 100 and/or one or more engagement bodies 138, can be determined at block 420 using information provided, for example, by the IMU 218.

In certain situations in which the agricultural machine 100 does not sink into the adjacent ground surface, the elevation (“h₃”) of the agricultural machine 100 at the designated reference point (e.g., the location sensor 210 or the roof of the cab 108 in this example) can be determined using the identified machine height to that reference point in view of the terrain elevation of the ground surface upon which the agricultural machine 100 is positioned. However, in other instances, the agricultural machine 100 may experience machine sink, also referred to as machine sink offset, wherein the engagement bodies 138 may be at an elevation below the recoded terrain elevation, as indicated, for example, by a terrain map. Such machine sink can be attributed to a variety of factors, including, for example, compaction of the soil along the track path(s) 140a-d on which an engagement body(ies) 138 is/are positioned, moisture content of the ground surface, and/or the weight of the agricultural machine 100, among other factors. In such situations, such machine sink can result in the reference point of the agricultural machine 100 being at an elevation that is lower than the elevation the reference point would have in the absence of machine sink. Thus, referencing the example, provided in FIG. 2C, the “machine sink” shown in FIG. 2C can represent a difference between the elevation at which the reference point of the agricultural machine 100 (e.g., the location sensor 210 or the roof of the cab 108) would be without machine sink, as generally indicated by line “A” in FIG. 2C, and the actual elevation of the reference point (as generally indicated by “h₄” at line “B” that the reference point of agricultural machine 100 may instead be lowered to if, due to machine sink, the engagement bodies 138 were below the terrain elevation (“h₂”). Thus, the extent of machine sink, and the corresponding offset in the elevation (“h₄”) of the agricultural machine 100 can be based, at least in part, on the extent or distance the agricultural machine 100, and, moreover, the engagement bodies 138, are below the adjacent terrain elevation (“h₂”). The extent of such machine sink, or machine sink offset, as determined for example, at block 422 by a controller 202, 232, can impact determinations as to the height settings for the agricultural machine 100, including, but not limited to, determinations of the height settings for the base cutters 114 and/or crop dividers 104, among other components of the header 115.

FIG. 2B provides, for at least purposes of illustration, an example of a scenario in which a presence machine sink, as well as changes in machine sink, as well as changes relating to a potential tilt of the agricultural machine 100 may be evaluated. Moreover, in the example provided by FIG. 2B, during a first pass of the agricultural machine 100, the agricultural machine 100 can travel in the field 141 from AB to A ‘B’. More specifically, during the first pass, the first, left side engagement body 138a of the agricultural machine 100 can travel along a first track path 140a, as depicted by line A-A ‘, while the second, right side engagement body 138b can travel along a second track path 140b, as depicted by line B-B’. During this travel of the agricultural machine 100 from AB to A ‘B’, the controller 202, 232, including the associated processor 204, 234, can utilize information provided by the location sensor 210 or location system 220, or other on-board elevation sensor, the height of the agricultural machine 100, and terrain elevation information from a terrain map to determine the extent, if any, of machine sink, of the agricultural machine 100, as indicated by block 420. Moreover, such a machine sink of the agricultural machine 100 can, as discussed above, be determined using the current machine height of the agricultural machine 100 in view of a determination of the difference between the current elevation measured using the location sensor 210, the location system 220, or other on-board elevation sensor, and the ground surface or terrain elevation information provided by the terrain map.

Further, a determination of the machine sink can be utilized to determine an elevation for both of the track paths 140a, 140b, individually using, for example, at least information relating to a tilt of the agricultural machine 100. For example, as previously discussed, the IMU 218 can provide information at block 420 that can be used at block 424 to determine a tilt, also referred to as a tilt offset, of the agricultural machine 100, such as, for example, a incline, slope, or roll of the agricultural machine in one or more directions generally across the agricultural machine 100 between the first engagement body 138a to the second engagement body 138b. Further, the determined elevation of the agricultural machine 100, which may be determined at block 420, and associated sink, as determined at block 422, can correspond to the location of the on-board elevation sensor, such as, for example, the location sensor 210 (also referred to herein above as the reference point). Knowledge of the elevation at the reference point, the position of that reference point relative to either or both of the engagement bodies 138, the machine sink (as determined at block 422), and the tilt information determined at block 424 can be utilized by the controller 202, 232 in determining, at block 426, the elevation of each of the first and second track paths 140a, 140b and/or the associated engagement bodies 138 at least at the currently known location of the agricultural machine 100, as identified at block 412. Knowledge of the elevation of the first and second track paths 140a, 140b and/or of the associated engagement bodies 138, including differences between the elevation of the track paths 140a, 140b and/or of the associated engagement bodies 138 relative to the adjacent terrain elevation, can at least assist in the controller 202, 232, including the associated processor 204, 234, in determining at least certain setpoints, such as, for example, height settings for the agricultural machine 100, and/or components of the header 115, including, for example, each base cutter 114a, 114b and the crop dividers 104, among other components at least toward the front end of the agricultural machine 100. Additionally, such knowledge of the elevation of each track path 140a, 140b and/or of the engagement bodies 138 can be utilized in proactively predetermining setpoints at a location corresponding to a lookahead distance, as discussed below.

Continuing with the example shown in FIG. 2B, upon completion of the first pass, the agricultural machine 100 can perform a turn in a second headland 142b such that the agricultural machine 100 is positioned to travel from B′C′ to BC. Thus, during such an exemplary second pass, the first, left side engagement body 138a is positioned to travel, and subsequently travels, along a third track path 140c from C′ to C, while the second, right side engagement body 138b is again positioned to travel, and travels, along the second track path 140b from B′ to B. Thus, according to such an example, the second track path 140b is traveled along during both the first and second passes by the second engagement body 138b. As the second track path 140b may have been compacted, or further compacted, by the travel of the second engagement body 138b from B to B′ during the first pass, the elevation of the second track path 140b may have changed as a result of the first pass and/or be further changed by the second pass. Thus, during the second pass from B′ to B, the elevation of the second track path 140b, and associated ground engagement body 138b can again be determined at block 426 in a manner that is similar to that discussed above with respect to the first pass, including with respect to again determining at least the machine sink offset (block 422) and machine tilt offset (block 424) to again determine the elevation along the second track path 140b and/or of the second engagement body 138b, as well the elevation of the third track path 140c and/or first ground engagement body 138a at identified locations along the second track path 140b. Thus, while for at least comparative reasons the elevation determined for the second track path 140b and/or second engagement body 138b in association with the first pass can be considered during the second pass of the agricultural machine 100, the elevation of the second track path 140b and/or second engagement body 138b can again be determined at block 426 for at least purposes of the second pass and associated travel of the second engagement body 138b from B′ to B. Additionally, the elevation of the third path 140c and/or first engagement body 138a can also be determined at block 426 in a manner similar to that mentioned above for the first and second paths 140a, 140b. Such determination of the track path 140a-d elevations and/or elevations of the ground engagement bodies 138a, 138b at blocks 426 can thus, if necessary, be repeatedly determined if there are multiple passes along a particular path 140a-d. Further, again, such determinations of the elevation of each track path 140a-d and/or the ground engagement bodies 138a, 138b, as well as information regarding machine sink (block 422) and machine tilt (block 424) can be utilized in proactive predeterminations of setpoints relating to at least height settings for the header 115, or associated components thereof, among other components of the agricultural machine 100, at lookahead distances, as discussed below.

At block 428, the controller 202, 230, including the associated processor 204, 234, can utilize information regarding a determined terrain elevation at the lookahead distance, as mentioned above with respect to block 418, as well as also utilize any one, or any combination of, the determined machine sink (block 422), machine tilt (block 424), and/or track elevation(s) (block 426) at the current location of the agricultural machine 100, as identified at block 412, to proactively predetermine one or more setpoints for the height of the agricultural machine 100, header 115, or one or more components of the header 115, at the lookahead location associated with the lookahead distance before the agricultural machine 100 reaches that lookahead location. Thus, for example, the controller 202, 230 may identify changes in terrain elevation between the current location of the agricultural machine 100 and the lookahead location based on the lookahead distance, if any, to determine whether any setpoints for the header 115, including, for example, setpoints relating to the height of the agricultural machine 100, header 115, base cutters 114 and/or crop dividers 104, among other components of the agricultural machine 100, are to be changed based on the anticipated upcoming change in terrain elevation. The controller 202, 230 can also evaluate the extent machine offset and tilt, and, moreover, the elevation of the track paths 140a-d upon which the agricultural machine 100 is, and will be traveling at the lookahead location, may further influence the setpoints for the agricultural machine 100, header 115, or component thereof, are to be adjusted, including, for example, setpoints relating to machine height, height of the base cutters 114, and/or height of the crop dividers 104, among other height setpoints.

If at block 428 the controller 202, 232, including the associated processors 204, 234, determine that setpoints are to be changed or adjusted for the lookahead location associated with the lookahead distance, then at block 430, those predetermined setpoints can be stored, such as, for example, by the memory device 206 or database 230. Additionally, these proactively determined setpoints can also be displayed to the operator at block 430, including, for example, in response to one or more signals generated by the controller 202, 232 for display of the setpoints on the user interface 227. Additionally, at block 432, the controller 202, 232, including the associated processors 204, 234, can, at block 432, generate one or more signals to one or more of the height actuators 226, among other actuators, to proactively facilitate a change in one or more settings of the header 115 based on the setpoints determined at block 428. Again, the timing of such activation of the height actuators 226, among other actuators, can be based at least in part on one or more of inherent latencies of the system and/or the rate of travel of the agricultural machine 100 such that adjustment of the header 115, or components thereof, is generally completed at, or around, the arrival of the agricultural machine 100 at the lookahead location associated with the look ahead distance. Thus, for example, the controller 202, 230 can generate one or more signals for activation of one or more height actuators 226 such that the height of one or more of the agricultural machine 100, base cutters 114, and/or crop dividers 104, among other components of the agricultural machine 100, attain a height associated with the determined setpoints before, or just as, those components reach the lookahead location associated with the lookahead distance.

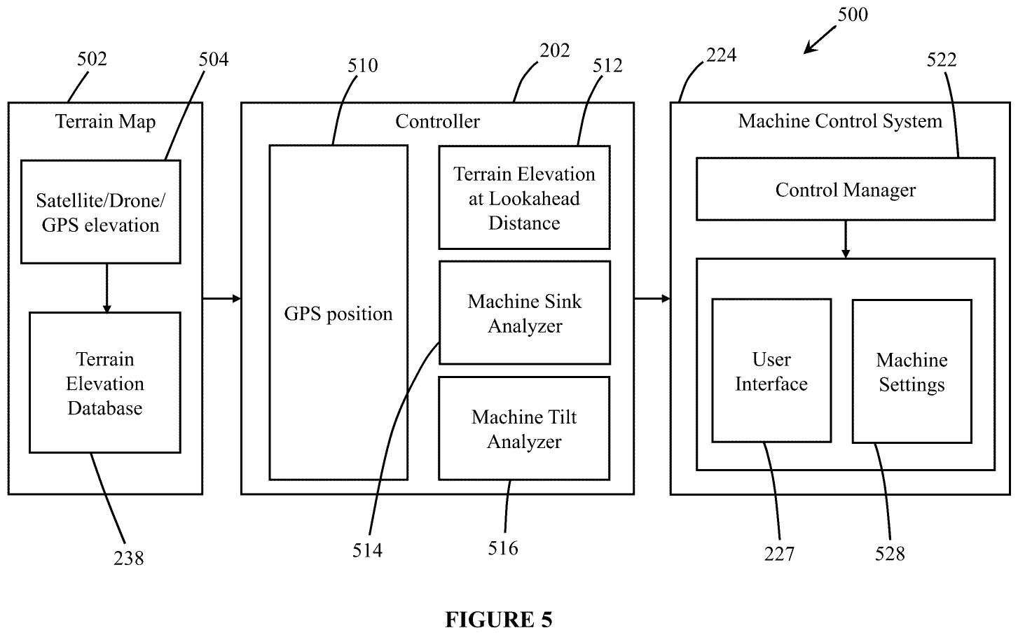

FIG. 5 illustrates a simplified block diagram of an exemplary portion of the system 200 shown in FIG. 3 for proactively determining and adjusting setpoints for one or more components of an agricultural machine 100. As illustrated, block 502 can correspond to a terrain map, which, as previously discussed, can include at least terrain elevation information provided by at least the aerial imaging device 226, as previously discussed for example with respect to at least block 402 in FIG. 4. Additionally, the terrain map can further include information from the terrain elevation database 238, which again, correspond to prior historical information gathered by operation of one or more agricultural machines 100, as well as information that may be obtained from other external sources, including, for example, the USGS. Thus, the terrain map referenced at block 502, which can also be referred to as an elevation map, includes terrain elevation data, among other topography and/or field information.

Information provided by the elevation or terrain map (block 502) can be provided to the controller 202, as indicated in FIG. 5 and discussed above with respect to at least FIG. 4. As indicated by at least block 510 in FIG. 5, the controller 202 can also receive location information for the agricultural machine 100 including, for example, GPS information, among other information that can be received or otherwise derived by use of the location sensor 210 and/or the location system 220, as previously discussed. Additionally, as discussed with respect to at least blocks 412 through block 418 in FIG. 4, the controller 202 can further determine, using information provided by at least block 502, a terrain elevation at the lookahead location associated with the lookahead distance, as indicated by block 512. Additionally, as indicated by blocks 514 and 516 in FIG. 5, the controller 202 can analyze a variety of information, including, but not limited to, terrain elevation information provided by block 502, historical information from the database 230, elevation information provided by one or more onboard sensors of the agricultural machine 100, including, for example, by the location sensor 210 and/or the location system 220, and tilt related information provided by the IMU 218, to derive information regarding the machine sink and machine tilt, respectively.

As also seen in FIG. 5, based at least on the above-identified information, the controller 202, including the associated processor 204, can generate one or more signals to facilitate an operation of the machine control system 224, including, for example, a control manager 522 of the machine control system 224. For example, the control manager 522 can be utilized in generating one or more signals for the activation of one or more actuators 226 of the agricultural machine 100 based on one or more setpoints determined by the controller 202, including, for example, setpoints relating to the height of the agricultural machine 100 and/or components thereof, including, for example, the header 115 or associated components. Further, such control of the actuators 226, including, but not limited to, one or more height actuators 226, can be utilized to proactively adjust a position, including height, of one or more components, including for example, a machine height, height of the base cutters 114, and/or height of the crop divider 104, such that such components are at a predetermined setpoint height upon, or around the time of, arrival at the lookahead location associated with the lookahead distance, as previously discussed. Additionally, the control manager 522 can be utilized in connection with communicating one or more of the predetermined setpoints to an operator of the agricultural machine 100, including, for example, via a display of at least some of the predetermined setpoints on the user interface 227.

Referencing FIG. 2B, in at least certain situations, the inclination or elevation of the ground surface at, or around, the headlands 142a, 142b, can be greater than that at the terrain or area of the field 141 having crop material that is being planted, sprayed, or harvested, among other agricultural operations. With respect at least certain types of agricultural machines 100, such differences in elevation between the headlands 142a, 142b, and the field 141 can create potential problems. For example, such a difference in the elevation of the headland 142a, 142b can potentially result in a crop divider 104 digging, and the base cutter 104 cutting, into the adjacent ground as the agricultural machine 100 reaches the end of the crop row in the field 141 and/or exits from the field 141 and enters into an adjacent headland 142a, 142b. Similarly, as the agricultural machine 100 is transitioning from a headland 142a, 142b to the field 141, such as, for example, as the agricultural machine 100 is at the start of a crop row, or is about to start an agricultural operation at, or around, the start of the crop row, the components at the front of the agricultural machine 100, including, for example, the header 115, base cutter 114, and/or crop divider 104, and/or the chassis of the agricultural machine 100 can be lowered to preset setpoints relating to heights associated with the agricultural machine 100 performing the associated agricultural operation. Yet, the differences in terrain elevations between the headland 142a, 142b and the field 141 can interfere with the movement of such components of the agricultural machine 100 and/or at least initially adversely impact the agricultural operation that the agricultural machine 100 is to perform. Thus, as discussed below, embodiments of the subject disclosure also accommodate use of predictive field terrain elevation map input to determine setpoints for one or more of the agricultural machine 100 and associated components relating to the agricultural machine 100 transitioning into/from an adjacent headland 142a, 142b and the associated starting and stopping or ending of an agricultural operation due to such transitions. Further, embodiments of the subject disclosure provide for predictive determinations of end of row setpoints, including end of cutting setpoints at the end of such crop rows, and a return to cut height setpoints, or a start of such cutting operations, for at least front-end components of the agricultural machine 100. Such setpoints can, for example, relating to the height of the header 115, base cutter 114, crop dividers 104, and/or the machine height, including, for example, the height of the chassis 132, among other components of the agricultural machine 100.

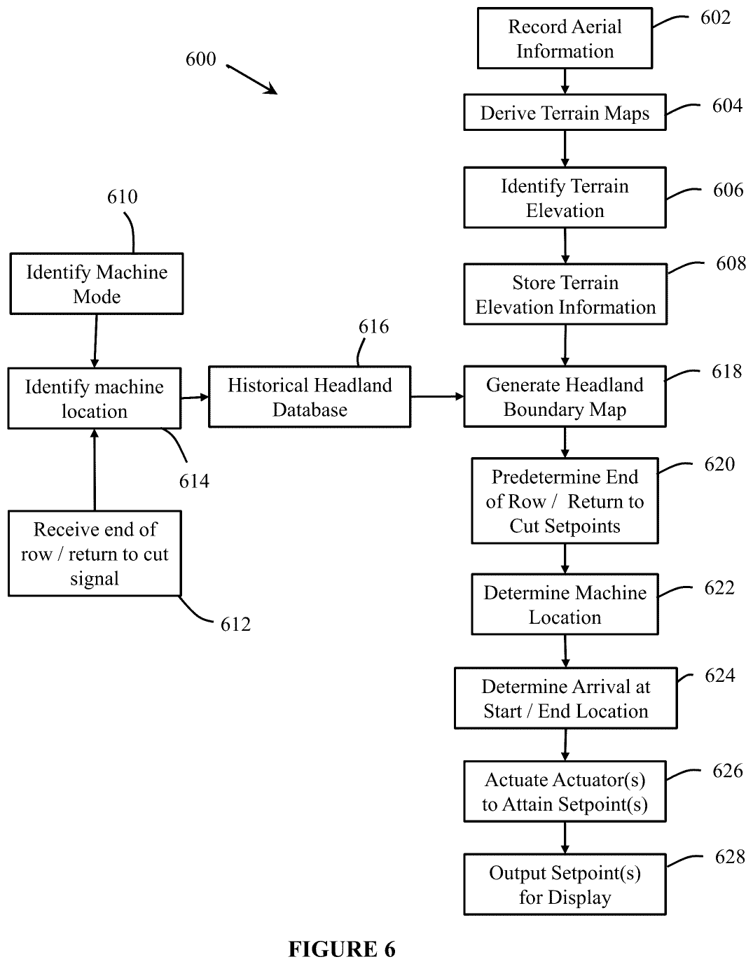

FIG. 6 illustrates a simplified flow diagram of an exemplary method 600 for proactively determining and adjusting height setpoints for one or more components of an agricultural machine based at least on terrain elevations at the start and end points for harvesting crop material. While discussed in terms of harvesting, the method 600 however is applicable to a variety of agricultural operations. The method 600 is described below in the context of being carried out by the illustrated exemplary system 200. However, it should be appreciated that method 600 can likewise be carried out by any of the other described implementations, as well as variations thereof. Further, the method 600 corresponds to, or is otherwise associated with, performance of the blocks described below in the illustrative sequence of FIG. 6. It should be appreciated, however, that the method 600 can be performed in one or more sequences different from the illustrative sequence. Additionally, one or more of the blocks mentioned below may not be performed, and the method 600 can include steps or processes other than those discussed below.

As seen in FIG. 6, at block 602, aerial information can be recorded, such as, for example, field data obtained via use of one or more aerial imaging devices 226. For example, as previously discussed, such recorded aerial information can correspond to terrain elevation information provided by a drone or satellite, including, for example, via use of lidar. Additionally, or alternatively, historical field data can be gathered, including, for example, terrain elevation information at a variety of locations about a field 141 and/or associated headlands 142a, 142b, that are obtained while one or more agricultural machines perform an agricultural operation, including, but not limited to, planting and/or spraying, among other operations, or in connection with one or more harvesting cycles, as discussed above. According to certain embodiments, such recorded aerial information can further include information provided by a mapping system 222 of an agricultural machine 100, or from some other source, including, for example, the USGS. Additionally, as previously discussed, such aerial information recorded at step 602 can be stored by the database 230, including, for example, one or more of the terrain elevation database 238, headland database 240, and/or the memory device 236.

At block 604, one or more controllers 202, 232, including one or more associated processors 204, 234, of the agricultural machine 100 and/or the database 230 can utilize at least the information provided by either or both the recorded aerial information from block 602 and/or the recorded historical information to derive the terrain map. Additionally, as indicated by block 606, to the extent not already provided by the terrain map, topographical information, including, for example, terrain elevation information at one or more locations, can be identified, included, updated, and/or supplemented for the terrain map at block 604. The terrain map and associated terrain elevation information can be stored at block 608, including recorded, such as, for example, at the or the memory device 206 of the agricultural machine 100 and/or at the database 230, including, for example, at the terrain elevation database 238, headland database 240, and/or the memory device 236. As indicated by FIG. 6, the terrain elevation information can be provided to block 618 in connection with the controller 202, 232 generating a headland boundary map, which can, for example, correspond to the boundary locations of the headlands 142a, 142b and/or the elevations along the headlands 142a, 142b, including at the boundaries locations of the headlands 142a, 142b.

As also seen in FIG. 6, the method 600 can further include identifying, such as, for example, by the controller 202, a machine mode at block 610. The machine mode can, for example, correspond to one or more agricultural operations being performed by the agricultural machine 100. For example, the machine mode can correspond to a harvesting mode in which the agricultural machine 100 is harvesting a crop. However, the machine mode can also correspond to other operations of the agricultural machine 100 not relating to harvesting, such as, for example, a maneuvering mode (e.g., when making a turn in a headland), a travel mode in which the agricultural machine 100 is traveling along a field at a location at which crop is not being harvested, or a mode associated with the agricultural machine 100 conducting a turn in a headland 142a, 142b, among other machine modes. According to certain embodiments, the location at which a harvesting mode starts, as indicated by block 610, can be identified at block 614 using the current location of the agricultural machine 100, as determined using the location sensor 210 and/or the location system 220. Such information can therefore indicate a start of a row, including a start of a cutting of crop material in that row, among the start of other agricultural operations. Similarly, the location at which a harvesting mode ends, including the end of a cutting operation, among other agricultural operations, as indicated by block 610, can be identified at block 614 using the current location of the agricultural machine 100, as determined using the location sensor 210 and/or the location system 220. Thus, the start and end of certain machine modes, such as, for example, the harvest mode, and the corresponding location of the agricultural machine 100, as identified at block 614, can automatically provide an indication of the start and end locations of one or more crop rows and/or the start or end of an agricultural operation, including, for example, the start and ending locations for a cutting operation relating to harvesting crop.

Additionally, or alternatively, the start and end locations of one or more crop rows and/or associated agricultural operations can also be identified based upon the location of the agricultural machine (block 614) when an operator manually inputs a command or signal, such as, for example, via use of the user interface 227. For example, as the agricultural machine 100 reaches an end of a crop row, the operator may utilize the user interface 227 to trigger an activation of one or more actuators, such as, for example, one or more height actuators 226, so as to raise a height of one or more components of the agricultural machine 100 and/or to raise a height of the agricultural machine 100. Additionally, or alternatively, as the agricultural machine 100 reaches an end of a crop row, the operator may utilize the user interface 227 to trigger a deactivation of an agricultural operation, such as, for example, to end or stop, at least temporarily, a cutting of the crop by the agricultural machine 100. Thus, according to certain embodiments, upon reaching an end of a crop row, by engagement with the user interface 227, the operator can initiate the controller 202 generating a signal to raise one or more components at the front end of the agricultural machine 100, including, for example, the header 115, the base cutter 114, and/or the crop dividers 104, and/or to end or stop, at least temporarily, the cutter 114 from cutting the crop. Again, such raising of the height of one or more components of the agricultural machine 100, and/or of the agricultural machine 100, can also be initiated in view of a difference in elevation between the adjacent headland 142a, 142b the agricultural machine 100 is entering, and adjacent portion of the field 141 being exited by the agricultural machine 100. The location of the agricultural machine 100 at the time the operator engages the user interface 227 for such raising of the agricultural machine 100 and/or components thereof, can be identified using the location information attained at block 416.

Similarly, as the agricultural machine 100 moves out of a headland 142a, 142b and enters a field 141, the agricultural machine 100 can reach a start point of crop row at which the agricultural machine 100 is to start harvesting crop, including, for example, to start again cutting crop in connection with a harvesting operation. Accordingly, at the start point, the operator can utilize the user interface 227 to trigger an activation, such as, for example, in response to one or more signals generated by the controller 202, of one or more actuators, such as, for example, one or more height actuators 226, so as to lower a height of one or more components of the agricultural machine 100, lower a height of the agricultural machine 100, and/or activate the cutter 114 such that the agricultural machine 100 can return to cutting crop. Moreover, according to certain embodiments, upon reaching a starting point for a crop row, by engagement with the user interface 227, the operator can cause the controller 202 to generate one or more signals to initiate a lowering of one or more components at the front end of the agricultural machine 100, including, for example, the header 115, the base cutter 114, and/or the crop dividers 104, as well as any combinations thereof, among other components of the agricultural machine 100. Again, such lowering of the height of one or more components of the agricultural machine 100, and/or of the agricultural machine 100, can be initiated in view of a difference in terrain elevation between the adjacent headland 142a, 142b the agricultural machine 100 is exiting, and adjacent portion of the field 141 being entered by the agricultural machine 100. The location of the agricultural machine 100 at the time the operator engages the user interface 227 for triggering such a lowering of the agricultural machine 100 and/or components thereof, can be identified using the location information attained at block 416.

The location of the agricultural machine 100 at which the machine mode 610, including activation of, or change to, a particular machine mode 610, is identified and/or the location at which a signal is received from the manual input by the operator indicating the start or end of an agricultural operation and/or of the crop row can be recorded, such as, for example, by the historical headland database 616 and/or the memory device 206. Such historical information, as well as the terrain elevation information from block 608 can be used by the controller 202, 232 at block 618 to generate a headland boundary map. Accordingly, information relating to changes in elevation, as provided by the terrain elevation information, as well as the automatic and/or manual information indicative of the starts and ends of crop rows and/or of an agricultural operation (e.g. start and end locations for crop cutting), as discussed above with respect to blocks 610, 612, 614, can be utilized to derive the headland boundary map. Accordingly, information provided for the headland boundary map can be used to determine, at block 620, setpoints for the particular locations that are the start and end locations at which crop is being cut among different, or a plurality, of crop rows. Moreover, either or both the start and end setpoints may, or may not, be different for different crop rows.

During an agricultural operation, such as, for example, a harvesting operation, the location sensor 210 and/or the location system 220 can be utilized to determine, at block 622, a current location of the agricultural machine 100. The location information provided at block 622 can also include a variety of other information, including, for example, a direction of travel the agricultural machine, as well as a speed of travel of the agricultural machine 100, which, as previously discussed, can be determined in a variety of different manners, including via use of information provided by the location sensor 210, location system 220, and/or via the speed sensor 212. Moreover, the information provided at block 622, as well as at least the start/end setpoint information provided by block 620, can at least assist in the controller 202 with determining at block 624 when the agricultural machine 100 will reach a start or end location of one or more crop rows and/or a start and end location at which an agricultural operation (e.g., crop cutting operation) is to either begin/resume or end. The information provided by at least block 620 and block 622, as well as information regarding inherent system latencies, can be utilized by the controller 202 to proactively determine at block 624 when to activate, at block 626, one or more actuators, including, for example, one or more height actuators 226 so that the agricultural machine 100 and/or one or more components at the front end of the agricultural machine 100, including, for example, the base cutter 114 and crop divider 104, are at predetermined heights so as to either start or end an agricultural operation (e.g. crop cutting operation). Further, such proactive adjustment of one or more heights of the agricultural machine 100 via activation of one or more actuators at block 626 can be implemented so as timely compensate for changes in terrain elevation between a header 142a, 142b and the field 141, as previously discussed. Additionally, at block 628, the controller 202 can generate one or more signals to display a plurality of information relating to the headland boundary map generated at block 618, the identified start or end of a crop row(s), a return or ending location for the agricultural operation, and/or the setpoints determined at block 620, the activation of the actuators at block 626, and the corresponding heights relating to the activated actuators 226, among other information.

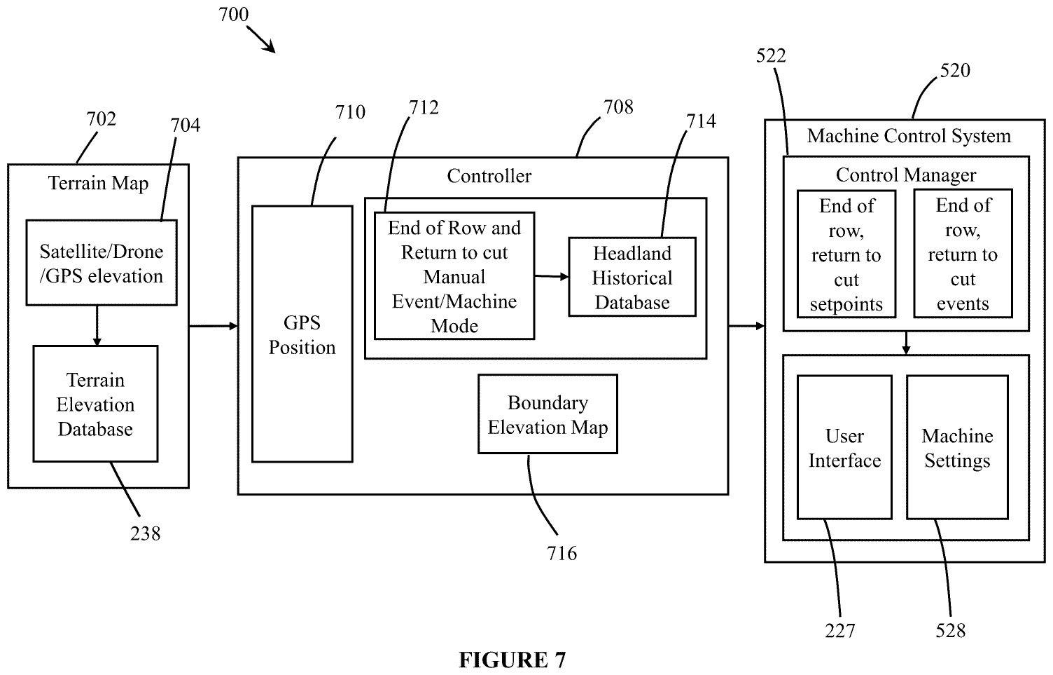

FIG. 7 illustrates a simplified block diagram of an exemplary portion of the system shown in FIG. 3 for proactively determining and adjusting setpoints for one or more components of an agricultural machine 100. As illustrated, block 702 can correspond to a terrain map, which, as previously discussed, can include terrain elevation information provided by at least the aerial imaging device 226, as previously discussed for example with respect to at least block 602 in FIG. 6. Additionally, the terrain map can further include information from the terrain elevation database 238, which again, correspond to prior historical information gathered by operation of one or more agricultural machines, as well as information that may be obtained from other external sources, including, for example, the USGS. Thus, the terrain map referenced at block 702 can include terrain elevation information, among other topography and/or field information.

Information provided by the terrain map (block 702) can be provided to the controller 202, as indicated in FIG. 7 and discussed above with respect to at least FIG. 6. As indicated by at least block 710 in FIG. 7, the controller 202 can also receive location information for the agricultural machine 100 including, for example, GPS information, among other information that can be received or otherwise derived by use of the location sensor 210 and/or the location system 220, as previously discussed. Additionally, as discussed with respect to at least blocks 610, 612, and 614, the controller 202 can further receive information regarding the start and end locations along one or more crop rows for an agricultural operation (e.g. cutting crop), which, again can be determined, for example, automatically via identification of a machine mode(s), or via an manual input provided by an operator, as discussed above with respect to at least blocks 610, 612, 614 in FIG. 6. Further, as seen by block 714, and as discussed above with respect to at least block 616 of FIG. 6 and with respect to FIG. 3, such information from block 712 can be stored at the headland historical database 240. The information generated at block 712 and/or stored at block 714, as well as the elevation map information from block 702 can be utilized by the controller 202 to generate the boundary elevation map 716, which can include an identification of corresponding locations for the start and end of row locations and/or for the associated agricultural operation, as discussed above with respect to at least block 618 in FIG. 6.

As also seen in FIG. 7, the controller 202 can use such terrain elevation, machine location, and/or start/stop locations, among other information, to generate one or more signals for operation of the machine control system 224, including, for example, operation of a control manager 522 of the machine control system 224. For example, the control manager 522 can be utilized in generating one or more signals for the activation of one or more actuators 226 of the agricultural machine 100 based on the identified end of row location and/or location of the end, at least temporarily, of agricultural operation, and the corresponding, start of row and/or start, including return, to performance of the agricultural operation, as well as the associated terrain elevations, or changes in terrain elevations, at those locations, including differences relating to changes in elevation due to entering/exiting a headland 142a, 142b. Further, such control of the actuators 226, including, but not limited to, one or more height actuators 226, can be utilized to proactively adjust a position, including height, of one or more components, including for example, a machine height, height of the base cutters 114, and/or height of the crop divider 104. Such proactive adjustment in height setpoints can, again, compensate for changes in terrain elevation relating to at least headlands 142a, 142b in view of the determined start/end of row locations and return/end of agricultural operation (e.g., crop cutting). Additionally, the control manager 522 can be utilized in connection with communicating one or more predetermined setpoints to an operator of the agricultural machine 100, including, for example, display of the predetermined setpoints on the user interface 227.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A system for proactively adjusting a height of a component of an agricultural machine, the system comprising:
a first sensor;
an actuator configured to drive an adjustment in the height of the component;
at least one processor; and
a memory coupled with the at least one processor, the memory including instructions that when executed by the at least one processor cause the at least one processor to:
identify, using information provided by the first sensor, a location and an elevation of the agricultural machine;
determine, using information provided by a terrain map, a first terrain elevation at the location of the agricultural machine;
determine, using information provided by at least the terrain map, a second terrain elevation at a lookahead location at a lookahead distance from the agricultural machine;
determine, using at least the first terrain elevation, the elevation of the agricultural machine, and a machine height of the agricultural machine, a machine sink of the agricultural machine;
determine, prior to an arrival of the agricultural machine at the lookahead location, and using at least the first terrain elevation, the second terrain elevation, and the machine sink, a setpoint for the height of the component; and
generate one or more signals to actuate, prior to an arrival of the agricultural machine at the lookahead location, the actuator to satisfy the setpoint at least upon arrival of the agricultural machine at the lookahead location.

2. The system of claim 1, wherein the memory further includes instructions that when executed by the at least one processor cause the at least one processor to determine, using information from a second sensor, a tilt offset of the agricultural machine, and wherein the setpoint is further determined using at least the tilt offset of the agricultural machine.

3. The system of claim 2, wherein the memory further includes instructions that when executed by the at least one processor cause the at least one processor to determine, using at least the tilt offset, a track elevation for one or more track paths, and wherein the setpoint is further determined using at least the track elevation.

4. The system of claim 2, wherein the memory further includes instructions that when executed by the at least one processor cause the at least one processor to determine, using at least the tilt offset, a ground engagement body elevation for one or more ground engagement bodies of the agricultural machine positioned on one or more track paths, and wherein the setpoint is further determined using at least the ground engagement body elevation.

5. The system of claim 1, wherein the first sensor comprises one or more of a location sensor, a speed sensor, a location system, and an elevation sensor.

6. The system of claim 5, wherein the memory further includes instructions that when executed by the at least one processor cause the at least one processor to determine, using at least information provided by the first sensor, at least one of the lookahead distance, the lookahead location, a time until an arrival of the agricultural machine at the lookahead location, and a time for a travel along the lookahead distance.

7. The system of claim 1, wherein the height corresponds to a height of at least one of the agricultural machine, a chassis of the agricultural machine, and one or more components of a header of the agricultural machine.

8. The system of claim 1, wherein the component comprises at least one of a base cutter and crop row divider.

9. A method for proactively adjusting a height of a component of an agricultural machine, the method comprising:
identifying, using information provided by a first sensor, a location and an elevation of the agricultural machine;
determining, using information provided by a terrain map, a first terrain elevation at the location of the agricultural machine;
determining, using information provided by at least the terrain map, a second terrain elevation at a lookahead location at a lookahead distance from the agricultural machine;
determining, using at least the first terrain elevation, the elevation of the agricultural machine, and a machine height of the agricultural machine, a machine sink of the agricultural machine;
determining, prior to an arrival of the agricultural machine at the lookahead location, and using at least the first terrain elevation, the second terrain elevation, and the machine sink, a setpoint for the height of the component; and
adjusting, via an activation of an actuator, and prior to an arrival of the agricultural machine at the lookahead location, the height of the component to satisfy the setpoint at least upon arrival of the agricultural machine at the lookahead location.

10. The method of claim 9, further comprising determining, using information from a second sensor, a tilt offset of the agricultural machine, and wherein determining the setpoint further comprises determining the setpoint using at least the tilt offset of the agricultural machine.

11. The method of claim 10, further comprising determining, using at least the tilt offset, a track elevation for one or more track paths, and wherein determining the setpoint further comprises determining the setpoint using at least track elevation.

12. The method of claim 10, further comprising determining, using at least the tilt offset, a ground engagement body elevation for one or more ground engagement bodies of the agricultural machine positioned on one or more track paths, and wherein determining the setpoint further comprises determining the setpoint using at least the ground engagement body elevation.

13. The method of claim 9, wherein the height corresponds to a height of at least one of the agricultural machine, a chassis of the agricultural machine, and a header of the agricultural machine.

14. The method of claim 9, wherein the component comprises at least one of a base cutter and crop row divider.

15. A system for proactively adjusting a height of a component of an agricultural machine to compensate for travel across a headland, the system comprising:
a first sensor;
an actuator configured to provide a force for an adjustment in the height of the component;
at least one processor; and
a memory coupled with the at least one processor, the memory including instructions that when executed by the at least one processor cause the at least one processor to:
receive a signal indicative of at least one of a machine mode of the agricultural machine and a change in an operation of the agricultural machine;
identify, using information provided by the first sensor, a first location of the agricultural machine associated with the signal, the first location being adjacent to the headland;
determine, using at least information provided by a terrain map, a first elevation for the first location; and
determine a setpoint for the height of the component at the first location, the setpoint being based at least on a difference between the first elevation and an elevation of the headland.

16. The system of claim 15, wherein the machine mode is a harvesting mode, a maneuvering mode, or a cutting mode.

17. The system of claim 16, wherein the system further comprises a user interface, and wherein the signal is generated from the user interface.

18. The system of claim 15, wherein the memory further includes instructions that when executed by the at least one processor cause the at least one processor to actuate, prior to a travel of the agricultural machine to the first location, the actuator to adjust the component to satisfy the setpoint at least upon the agricultural machine being at the first location.

19. The system of claim 15, wherein the first sensor comprises one or more of a location sensor, a speed sensor, a location system, and an elevation sensor.

20. The system of claim 15, wherein the height corresponds to a height of at least one of the agricultural machine, a chassis of the agricultural machine, and one or more components of a header of the agricultural machine.
